(19) United States
(12) Patent Application Publication
(10) Pub. No.: US 2026/0234837 A1
(43) Pub. Date: Aug. 13, 2026

(54) BLENDED CELLULOSE ACETATE FIBER AND PROCESS FOR THE MAKING THEREOF

(71) Applicant: Eastman Chemical Company, Kingsport, TN (US)

(72) Inventors: Marcus David Shelby, Fall Branch, TN (US); Freddie Wayne Williams, Kingsport, TN (US); Mark Edward Stewart, Kingsport, TN (US); James Collins Maine, Church Hill, TN (US); John Michael Allen, Kingsport, TN (US); Weijun Wang, Kingsport, TN (US); Yan Jin, Piney Flat, TN (US)

(73) Assignee: Eastman Chemical Company, Kingsport, TN (US)

(21) Appl. No.: 19/469,739

(22) PCT Filed: Mar. 19, 2024
(86) PCT No.: PCT/US2024/020485

§ 371 Date: Sep. 26, 2025

Related U.S. Application Data
(60) Provisional application No. 63/455,291, filed on Mar. 29, 2023.

(51) Int. Cl. D01F 2/28; C08B 3/06; D01D 5/06; D02G 3/02; D04B 1/16

(52) U.S. Cl. CPC D01F 2/28; C08B 3/06; D01D 5/06; D02G 3/02; D04B 1/16; D10B 2201/28; D10B 2401/063

(57) ABSTRACT

A blended cellulose acetate fiber comprising at least two cellulose acetate constituents and a wet spinning process for producing the same from blended cellulose acetate dope.

### BACKGROUND

### Field of the Invention

The present application is generally related to fibers comprising a blend of cellulose acetate constituents. More particularly, the present application is related to the wet spinning of blends of at least two cellulose acetates into fiber.

### Description of the Related Art

Cellulose acetate fibers exhibit properties that are very desirable and useful for many applications. Cellulose acetates are cellulose esters that can be dissolved in solvents to form a viscous dope material which can then be extruded through one or more spinnerets to form fibers. Depending on the cellulose ester and the solvent, fibers may be dry spun under conditions that flash off the dope solvent by evaporation or fibers may be wet spun directly into the liquid of a coagulation bath where the fiber forms (coagulates) as the dope solvent migrates from the spun fiber into the liquid of the coagulation bath. Cellulose acetate (“CA”) fibers are typically produced from either cellulose triacetate material or cellulose diacetate material. Cellulose triacetate (“CTA”) fiber is defined in 16 CFR § 303.7 (e) as a manufactured fiber in which the fiber-forming substance is cellulose acetate where not less than 92% percent of the hydroxyl groups are acetylated. 92% acetylation is equivalent to a DS_{acetyl} Of 2.76. Thus CTA fiber exhibits an average DS_{acetyl} in the range from 2.76 up to 3.0. Cellulose diacetate (“CDA”) fiber is typically dry spun from acetone using CDA material with a DS_{acetyl} ranging from 2.1 to 2.7 (The Chemistry of Cellulose, by Emil Heuser, John Wiley & Sons, Inc. New York, p. 267-270). The addition of water to CDA/acetone dopes can enable dry spinning of cellulose diacetate fiber with DS_{acetyl} ranging down to 1.9. (U.S. Pat. No. 5,512,230). Thus CDA fiber typically exhibits an average DS_{acetyl} in the range from 1.9 up to 2.7.

Cellulose triacetate does not readily dissolve in acetone, requiring instead more polar organic solvents such as dichloromethane (methylene chloride) or a mixture of dichloromethane and methanol, which presents challenges at manufacturing scale both with the volatility and recoverability of the solvent and/or with employee health concerns related to potential occupational carcinogen exposure. CTA fiber wet spinning processes utilizing dichloromethane and methanol solvents are known in the art. Less hazardous solvents for wet spinning CTA fiber are also known, but require lower solids dope concentrations for stable operation and are, consequently, deselected due to the resulting lower process throughput. Cellulose diacetate is soluble in acetone and cellulose acetate fibers spun from CDA, filter tow and textile acetate yarn for example, are commonly dry spun at commercial scale via acetone solvent dry spinning processes.

While cellulose acetate fibers are somewhat weaker than synthetic polymeric fibers such as polyester, acrylic, and nylon, CA fibers offer some benefits that such higher strength fibers do not. CA textile fibers have a luxurious appearance, inherent softness and reduced pilling and therefore typically find application in high fashion garments and comfortable casual womenswear. Cellulose acetate fibers can be produced from sustainably harvested renewable raw materials as opposed to fossil fuel based synthetic polymer fibers. WO 2016/127833 A1 discloses blending CDA with acrylic polymer in order to improve the moisture regain and comfort of the acrylic fiber. CTA, however, does not exhibit the same moisture regain characteristic of CDA and can thereby contribute to increased static cling and decreased comfort in humid conditions. CTA fibers are generally recognized as having better wash and wear performance than CDA fibers. Textiles produced from cellulose acetate fibers, both CTA and CDA, are recognized for characteristics such as pleatability, brightness, and lustre.

Dry spinning, wet spinning and hybrid dry-wet spinning processes for producing CDA and CTA fibers have been disclosed, but the prior art all suffers from one or more disadvantages or deficiencies. The physical properties of CTA fibers are, on balance, superior to the physical properties of CDA fibers. CTA however, also requires, on balance, higher quality raw materials than CDA and is therefore more expensive to manufacture. In addition to the raw material cost differences, CTA fiber production processes also face the additional challenges and expenses associated with hazardous solvents. Conversely, CDA fibers are produced from lower cost raw materials and do not require the same hazardous solvents as CTA, yet they fail to deliver the physical property performance of CTA fibers.

Thus, there is a need for a cellulose acetate fiber which exhibits the desirable balance of properties of CTA fibers with the moisture regain of CDA fibers while also being capable of being produced without the hazardous solvents and high cost raw materials of a pure CTA process.

### SUMMARY

In one or more aspects, the present technology concerns a blended cellulose acetate (“BCA”) fiber. Generally, the cellulose acetate fiber has a number average DS_{acetyl} of at least 2.6 and comprises at least two cellulose acetate constituents, the first constituent having a higher average DS_{acetyl} than that of the fiber and the second constituent having a lower average DS_{acetyl} than that of the fiber. Furthermore, the blended cellulose acetate fiber may exhibit a silk factor of at least 7.6, a tenacity of at least 1.6 g/denier as measured according to ASTM D22556 and an elongation at break of at least 15 percent as measured according to ASTM D22556. The fiber may also exhibit a higher moisture regain than cellulose triacetate fiber.

In one or more aspects, the present technology concerns a blended cellulose acetate dope. Generally, the BCA dope comprises at least two cellulose acetate constituents, the first constituent being a cellulose triacetate having a DS_{acetyl} of at least 2.75 and the second constituent being a cellulose diacetate having a DS_{acetyl} of less than 2.75, both constituents being at least partially dissolved in one or more (suitable) solvents comprising dimethyacetamide, dimethylformamide, or a combination thereof. Furthermore, the dope exhibits a DS_{acetyl} of at least 2.6. The BCA dope may exhibit a lower viscosity than a comparative dope having the same solvent(s) and solids concentration wherein the solids components consists of CTA.

In one or more aspects, the present technology concerns a process for producing a blended cellulose acetate (“BCA”) fiber. Generally, the process comprises: (a) forming a BCA dope having a DS_{acetyl} of at least 2.6 and at least two cellulose acetate constituents wherein at least one constituent is CTA and at least one constituent is CDA; (b) spinning said BCA dope through a spinneret to form one or more BCA fibers; and (c) drawing said one or more BCA fibers through a first coagulation bath at a jet draw stretching ratio in the range of 0.75:1 to 1.5:1. Optionally, the process further comprises one or more of the following characteristics:
a) the BCA dope as fed to the spinneret comprises at least 20 weight percent solids;
b) the first coagulation bath comprises water and up to 45 weight percent alkyl amide solvent;
c) the first coagulation bath temperature is no higher than 25° C.; and
d) the BCA fiber residence time in the first coagulation bath is no more than 10 seconds.

### BRIEF DESCRIPTION OF THE FIGURES

Embodiments of the present invention are described herein with reference to the following drawing figures, wherein:

FIG. 1—depicts an exemplary wet spinning system according to one embodiment of the present application;

FIG. 2—is a graph of Silk Factor and % CTA in the BCA fiber;

FIG. 3—is a graph of process throughput and % CTA in the BCA fiber;

FIG. 4—is a graph of Silk Factor and process throughput with various blend ratios identified; and

FIG. 5—is a graph of Moisture Pick-Up and % CTA in the BCA fiber.

### DETAILED DESCRIPTION

The present application generally relates to a blended cellulose acetate fiber which exhibits a combination of high tenacity and high elongation at break to yield excellent silk factors. Such fibers can be utilized in textiles, apparel, and filtration applications. The BCA fiber of the present invention can be formed from a blended cellulose acetate dope which comprises at least two cellulose acetate constituents, one CTA and one CDA, which are at least partially dissolved in a suitable solvent (e.g., dimethylacetamide, dimethylformamide, or combinations thereof). The BCA fibers can be formed from the BCA dope via a wet spinning process. In this process the BCA is extruded through one or more spinneret(s) into a coagulation bath comprising water and, optionally, a coagulation solvent and/or solvents. As the dope is extruded from the spinneret into the coagulation bath, it is formed into one or more BCA fibers. The coagulation bath conditions including solvent concentration, bath temperature, and residence time in the bath may be optimized to affect the solidification, formation, and resultant physical properties of the BCA fibers. The BCA fiber of the present invention may be drawn or stretched as they solidify in the coagulation bath by controlling the jet draw stretching ratio (“JDSR”) which is the ratio of the speed of the BCA fiber at the take-up roll relative to the velocity of the dope as it enters the coagulation bath at the spinneret face. Optimizing JDSR provides a mechanism for producing BCA fibers having high tenacity and elongation. Additionally, the fibers can be further stretched after the take up roll, or optionally not further stretched, in a post-drawing step which can impart additional crystalline orientation.

More particularly, it has been surprisingly discovered that wet spinning certain blend ratios of CTA and CDA enables higher process yields while also producing fibers with superior physical property performance. The differences in crystallinity and solubility of CTA relative to CDA necessitates lower CTA dope solids levels in order to produce a stable dope with sufficiently few gels and sufficiently low viscosity for processability in terms of ability to be pumped, to be filtered, and/or to be extruded through the small diameter orifice(s) in the face of the spinneret without negatively impacting spinning speed. At a given spinning speed, a lower solids dope produces less fiber over an equivalent time period than a dope having higher solids content while simultaneously increasing the load on any distillation/recovery equipment being utilized to recover and/or separate the solvent from the coagulant liquid composition. These factors can considerably increase the operational costs of a low solids dope process. The crystallinity of the CTA also contributes to rapid crystallization in the coagulation bath as the CTA fibers form, contributing to the generally high silk factor of CTA fiber. For given solvents, CDA dopes, having lower crystallinity than CTA, generally exhibit lower viscosity and solubility stability which enable them to be processed at higher solids. However, the intrinsically lower crystallinity of CDA as compared to CTA contributes to a slower crystallization in the coagulation bath, thus forming CDA fibers which generally exhibit lower tenacity and silk factor results. Dissolving a blend of CTA and CDA at certain ratios provides the lower dope viscosity and higher dope solids processability of CDA without negatively impacting the desirable tenacity and silk factor properties of CTA fiber. Surprisingly, blends from 50 wt % CTA and 50 wt % CDA up to blends of 75 wt % CTA and 25 wt % CDA, based on the weight of the solids in the dope, have been found to yield an optimal balance of dope processability and fiber properties. Blends having less than 25 wt % CDA and blends having more than 50 wt % CDA were found to exhibit poorer fiber properties than wet spun CTA fiber. The wet spinning process described herein may provide an optimal BCA fiber by controlling the jet draw stretching ratio, coagulation bath conditions, and/or other process variables within specific ranges to yield high tenacity, high elongation at break, and high silk factor results, as well as a higher moisture regain. The cellulose esters that may be utilized for the wet spinning process can include conventional CDA and CTA fiber spinning polymers. The blended cellulose acetate dope remains stable and processable at higher solids levels than pure CTA dopes having the same solvent system, thus enabling a higher throughput wet spinning process while maintaining desirable fiber properties.

The various characteristics and properties of the BCA fibers, the BCA dope, and the wet spinning process for converting the dope into the fiber are described below. It should be noted that, while all of the following characteristics and properties may be listed separately, it is envisioned that each of the following characteristics and/or properties of the wet spinning process, blended cellulose acetate dope, and blended cellulose acetate fibers are not mutually exclusive and may be combined and present in any combination.

The cellulose acetates blended to form the present invention can include any cellulose ester known in the art that contains an acetyl group and must comprise at least one cellulose triacetate and at least one cellulose diacetate. Cellulose esters that can be used for the present invention generally comprise repeating units of the structure:

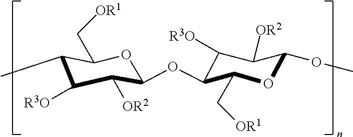

Wherein R¹, R², and R³ are selected independently from the group consisting of hydrogen or straight chain alkanoyl having from 2 to 10 carbon atoms.

For cellulose esters, the substitution level is usually expressed in terms of degree of substitution (“DS”), which is the average number of non-OH substituents per anhydroglucose unit (“AGU”). Generally, conventional cellulose contains three hydroxyl groups in each AGU that can be substituted; therefore, DS can have a value between zero and three. However, low molecular weight cellulose esters can have a total degree of substitution slightly above 3 due to end group contributions. Because DS is a statistical mean value, a DS value of 1 does not assure that every AGU has a single substituent. In some cases, there can be unsubstituted AGU's, some AGU's with two, and some with three substituents, and typically the value will be a non-integer. The “Total DS” is defined as the average number of all of the non-OH substituents per AGU. The degree of substitution per AGU can also refer to a particular substituent, such as hydroxyl, acetyl, propionyl, or butyryl for example.

In one embodiment, the BCA fiber exhibits a number average degree of substitution of acetyl (“DS_{acetyl}”) of at least 2.6, at least 2.61, at least 2.62, at least 2.63, at least 2.64, at least 2.65, at least 2.66, at least 2.67, at least 2.68, at least 2.69, at least 2.7, at least 2.71, at least 2.72, at least 2.73, at least 2.74, at least 2.75, at least 2.76, at least 2.8, at least 2.85, and not more than 3.0, not more than 2.95, not more than 2.90, not more than 2.85. In certain embodiments the BCA fiber exhibits a number average DS_{acetyl} in the range of 2.6 to 3.0, 2.61 to 3.0, 2.62 to 3.0, 2.63 to 3.0, 2.64 to 3.0, 2.65 to 3.0, 2.66 to 3.0, 2.67 to 3.0, 2.68 to 3.0, 2.69 to 3.0, 2.7 to 3.0, 2.71 to 3.0, 2.72 to 3.0, 2.73 to 3.0, 2.74 to 3.0, 2.75 to 3.0, 2.76 to 3.0, 2.7 to 2.9, 2.7 to 2.85, or 2.76 to 2.85. The number average DS_{acetyl} can be determined via nuclear magnetic resonance (“NMR”) with a precision of 0.01 units.

In one embodiment or in combination with any other mentioned embodiments, the BCA fiber comprises at least two cellulose acetate constituents. Cellulose acetate constituents can be identified through an acetone extraction process wherein a sample of BCA fiber is dissolved in acetone ambient conditions (approximately 25° C. and 1 atm) over a period of at least 48 hours. The resulting solution can be filtered via fritted funnel to separate the acetone soluble constituent material (filtrate) from the acetone insoluble constituent material (residue). In one embodiment or in combination with any other mentioned embodiments, the acetone insoluble constituent (extraction residue) exhibits a number average DS_{acetyl} which is greater than the number average DS_{acetyl} of the fiber sample prior to acetone extraction. In one embodiment or in combination with any other mentioned embodiments, the acetone soluble constituent (extraction filtrate) exhibits a number average DS_{acetyl} which is less than the number average DS_{acetyl} of the fiber sample prior to acetone extraction.

It has been found that blending certain ratios of CTA and CDA according to the present invention will produce blended cellulose acetate fibers that exhibit many of the physical properties of a CTA fiber while also enabling higher process throughput.

In one embodiment or in combination with any other mentioned embodiments, the acetone insoluble constituent from the acetone extraction of the BCA fiber is cellulose triacetate. In one embodiment or in combination with any other mentioned embodiments, the acetone soluble constituent from the acetone extraction of the BCA fiber is cellulose diacetate. In certain embodiments, the acetone insoluble constituent exhibits a number average DS_{acetyl} as measured by NMR of at least 2.76, at least 2.77, at least 2.78, at least 2.79, at least 2.8, at least 2.85, at least 2.9 and not more than 3.0. In certain embodiments the acetone insoluble constituent exhibits a number average DS_{acetyl} in the range of 2.7 to 3.0, 2.71 to 3.0, 2.72 to 3.0, 2.73 to 3.0, 2.74 to 3.0, 2.75 to 3.0, 2.76 to 3.0, 2.7 to 2.9, 2.7 to 2.88, or 2.76 to 2.86. In one embodiment or in combination with any other mentioned embodiments, the acetone soluble constituent exhibits a number average DS_{acetyl} as measured by NMR of at least 1.9, at least 2.0, at least 2.1, at least 2.2, at least 2.3, at least 2.38 and less than 2.75, less than 2.7, less than 2.65, less than 2.6, less than 2.55, less than 2.5, less than 2.45. In certain embodiments the acetone soluble constituent may exhibit a number average DS_{acetyl} as measured by NMR in the range of 1.9 to less than 2.75, 2.0 to less than 2.75, 2.1 to less than 2.75, 2.2 to less than 2.75, 2.0 to 2.7, 2.0 to 2.65, 2.1 to 2.6, 2.2 to 2.55, 2.3 to 2.5, or 2.38 to 2.45.

In one embodiment or in combination with any other mentioned embodiments, the BCA fiber can comprise a crystallinity of at least 5, at least 10, at least 15, at least 20, at least 25, or at least 30 percent as measured according to ASTM F2625 using an enthalpy of fusion of 58.8 J/g. Additionally or alternatively, in one embodiment or in combination with any other mentioned embodiments, the cellulose ester can comprise a crystallinity of not more than 40, not more than 35, not more than 30, or not more than 25 percent as measured according to ASTM F2625 using an enthalpy of fusion of 58.8 J/g. In certain embodiments, the cellulose ester can comprise a crystallinity of 5 to 40, 25 to 40, 25 to 35, or 30 to 35 percent as measured according to ASTM F2625 using an enthalpy of fusion of 58.8 J/g.

Silk factor (“SF”) is an empirically determined relationship between tenacity and elongation that is used to predict the failure envelope of a given fiber. Silk Factor can be used to characterize a yarn or fiber's suitability for use in a given process and is calculated based on the following formula:

$$Silk Factor = Tenacity * \sqrt{Elongation}$$

In one embodiment or in combination with any other mentioned embodiments, the BCA fiber has a silk factor of at least 7.6, at least 7.7, at least 7.8, at least 7.9 or at least 8.0 where elongation is expressed in percent and tenacity is in grams/denier.

Tenacity and elongation are physical properties of a fiber that define its strength and resistance to breaking. Tenacity is a critical property of a cellulose acetate fibers because it measures how much tensile force can be applied to the fiber before it breaks. A fiber with a lower tenacity can be pulled apart more easily than a fiber with a higher tenacity. For the purposes of textile manufacturing, a tenacity of less than 1.6 g/denier can be problematic because the fiber will break under regular operating conditions. In one embodiment or in combination with any other mentioned embodiments, the BCA fiber may exhibit a tenacity of at least 1.6. at least 1.7, at least 1.8, at least 1.9, at least 2.0, at least 2.1, at least 2.2, at least 2.3, at least 2.4, or at least 2.5 g/denier as measured according to ASTM D22556.

Elongation, also known as elongation at break, is expressed as a percentage and it is indicative of how much a yarn or filament will stretch before it breaks. In one embodiment or in combination with any other mentioned embodiments, the BCA fibers and/or the yarn produced therefrom may exhibit an elongation at break of at least 15, at least 16, at least 17, at least 18, at least 19, at least 20, at least 21, at least 22, at least 23, at least 24, at least 25, at least 26, at least 27, at least 28, at least 29, or at least 30 percent as measured according to ASTM D22556.

Moisture regain is a fiber property that expresses the amount of moisture a fiber or material will absorb when exposed to a specific level of humidity. Moisture regain can be correlated to moisture pickup and procedures for measuring both are described by ASTM D2654-22. Moisture pickup is expressed as a percentage based on the dried mass of the sample.

In one embodiment or in combination with any other mentioned embodiments, the BCA fiber exhibits a moisture pickup of at least 3.0%, at least 3.1%, at least 3.2%, at least 3.2%, at least 3.4%, at least 3.5%, at least 3.6%, at least 3.7%, at least 3.8%, at least 3.9%, at least 4.0%, at least 4.1%, or at least 4.25% as measured at 50% RH after drying in 120° C. oven for 1 hour.

In one embodiment or in combination with any other mentioned embodiments, the BCA fiber is a wet spun fiber.

In one embodiment or in combination with any other mentioned embodiments, the BCA fiber comprises cellulose acetate having at least one substituent on an anydroglucose unit derived from recycled plastic content syngas. The substituent can have recycled content that is provided by chemical recycling where waste material is broken down into small molecules, e.g., a waste stream (containing waste plastic) is gasified to produce syngas and the syngas is then utilized via one or more reaction schemes to produce the substituent.

In one embodiment or in combination with any other mentioned embodiments, the BCA fiber formed therefrom can be biodegradable. As used herein, the term “biodegradable” generally refers to the tendency of a material to chemically decompose under certain environmental conditions. The degree of degradation can be characterized by the weight loss of a sample over a given period of exposure to certain environmental conditions. In some cases, the BCA fiber can exhibit a weight loss of at least about 5, at least about 10, at least about 15, or at least about 20 percent after burial in soil for 60 days and/or a weight loss of at least about 15, at least about 20, at least about 25, at least about 30, or at least about 35 percent after 15 days of exposure in a composter. However, the rate of degradation may vary depending on the particular end use of the fibers. Exemplary test conditions are provided in U.S. Pat. Nos. 5,870,988 and 6,571,802, incorporated herein by reference.

In one embodiment or in combination with any other mentioned embodiments, the BCA fiber can be compostable. To be considered “compostable,” a material must meet the following four criteria: (1) the material must be biodegradable; (2) the material must be disintegrable; (3) the material must not contain more than a maximum amount of heavy metals; and (4) the material must not be ecotoxic. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one embodiment or in combination with any other mentioned embodiments, the BCA fiber can be industrially compostable, home compostable, or both. In such embodiments, the BCA fibers can satisfy four criteria: (1) biodegrade in that at least 90% carbon content is converted within 180 days; (2) disintigratable in that least 90% the material disintegrates within 12 weeks; (3) does not contain heavy metals beyond the thresholds established under the EN12423 standard; and (4) the disintegrated content supports future plant growth as humus; where each of these four conditions are tested per the ASTM D6400, ISO 17088, or EN 13432 method.

In one embodiment or in combination with any other mentioned embodiments, the BCA fiber can exhibit a biodegradation of at least 70 percent in a period of not more than 50 days, when tested under aerobic composting conditions at ambient temperature (28° C.±2° C.) according to ISO 14855-1 (2012). In some cases, the BCA fibers and/or the yarns formed therefrom can exhibit a biodegradation of at least 70 percent in a period of not more than 49, not more than 48, not more than 47, not more than 46, not more than 45, not more than 44, not more than 43, not more than 42, not more than 41, not more than 40, not more than 39, not more than 38, or not more than 37 days when tested under these conditions, also called “home composting conditions.” These conditions may not be aqueous or anaerobic.

In one embodiment or in combination with any other mentioned embodiments, the BCA fiber can exhibit a biodegradation of at least 60 percent in a period of not more than 45 days, when tested under aerobic composting conditions at a temperature of 58° C. (±2° C.) according to ISO 14855-1 (2012). In some cases, the BCA fiber can exhibit a biodegradation of at least 60 percent in a period of not more than 44 days when tested under these conditions, also called “industrial composting conditions.” These may not be aqueous or anaerobic conditions.

In one embodiment or in combination with any other mentioned embodiments, the present invention is a blended cellulose acetate dope having a number average DS_{acetyl} of at least 2.6 and comprising at least two cellulose acetate constituents which are dissolved in at least one dissolution solvent. In embodiments, at least one of the CA constituents is CTA and at least one of the CA constituents is CDA. As described above, The cellulose acetates blended to form the present invention can include any cellulose ester known in the art that contains an acetyl group and must include at least one cellulose triacetate and at least one cellulose diacetate. In embodiments, the cellulose triacetate exhibits a number average DS_{acetyl} as measured by NMR of at least 2.76, at least 2.77, at least 2.78, at least 2.79, at least 2.8, at least 2.85, at least 2.9 and not more than 3.0. In certain embodiments the cellulose triacetate exhibits a number average DS_{acetyl} in the range of 2.76 to 3.0, 2.7 to 2.9, 2.7 to 2.85, or 2.76 to 2.86. In one embodiments, the cellulose diacetate exhibits a number average DS_{acetyl} as measured by NMR of at least 1.9, at least 2.0, at least 2.1, at least 2.2, at least 2.3, at least 2.38 and less than 2.75, less than 2.7, less than 2.65, less than 2.6, less than 2.55, less than 2.5, less than 2.45. In certain embodiments the acetone soluble constituent may exhibit a number average DS_{acetyl} as measured by NMR in the range of 1.9 to less than 2.70, 2.0 to 2.65, 2.1 to 2.6, 2.2 to 2.55, 2.3 to 2.5, or 2.38 to 2.45.

In one embodiment or in combination with any other mentioned embodiments, the cellulose acetates can exhibit glass transition temperature of at least 120, at least 125, at least 130, at least 135, at least 140, at least 145, at least 150, at least 155, at least 160, at least 165, at least 170, or at least 175° C. and/or not more than 250, not more than 245, not more than 240, not more than 235, not more than 230, not more than 225, not more than 220, not more than 215, not more than 210, not more than 205, not more than 200, not more than 195, not more than 190, or not more than 185° C. To determine the T_{g} of the cellulose ester, the sample is dried to a moisture level below 10 weight percent.

The cellulose acetates can be produced by any method known in the art. Examples of processes for producing cellulose acetate are taught in Kirk Othmer, Encyclopedia of Chemical Technology, 5th Edition, Vol. 5, Wiley-Interscience, New York (2004), pp. 394-444.

One method of producing cellulose acetates involves esterification of the cellulose by mixing cellulose with the appropriate organic acids, acid anhydrides, and catalysts. Cellulose is then converted to a cellulose triester (triacetate) acid dope. Ester hydrolysis can be performed by adding water-acid mixture to the cellulose triacetate, lowering the DS into the diacetate range. The acid dope can then be filtered to remove any gel particles or fibers. Water is then added to the mixture to precipitate the cellulose acetate. The cellulose acetate can then be washed with water to remove reaction by-products followed by dewatering and drying.

Cellulose, the starting material for producing cellulose acetates, can be obtained in different grades and sources such as form cotton linters, softwood pulp, hardwood pulp, corn fiber, and other agricultural sources, and bacterial cellulose, among others. The starting material used to produce the cellulose acetates may affect the resulting hemicellulose content in the resulting cellulose acetates.

In one embodiment or in combination with any other mentioned embodiments, either one of the cellulose acetate components or both components may comprise a hemicellulose content of at least 0.5, at least 1, at least 2, at least 3, at least 4, at least 5, at least 6, or at least 7 weight percent. Additionally or alternatively, in one embodiment or in combination with any other mentioned embodiments, the cellulose ester can comprise a hemicellulose content of not more than 10, not more than 9, not more than 8, not more than 7, not more than 6, not more than 5, not more than 4, not more than 3, not more than 2, or not more than 1 weight percent.

Alternatively, in one embodiment or in combination with any other mentioned embodiments, the cellulose acetates may comprise no hemicellulose content.

In one embodiment or in combination with any other mentioned embodiments, the BCA dope comprises no less than 50, no less than 55, no less than 60, and no more than 75, no more than 70, no more than 65 weight percent CTA based on the weight of the cellulose acetate solids in the dope.

In one embodiment or in combination with any other mentioned embodiments, the BCA dope comprises no less than 25, no less than 30, no less than 35, and no more than 50, no more than 45, no more than 40 weight percent CDA based on the weight of the cellulose acetate solids in the dope.

The dissolution solvent comprises one or more solvents capable of dissolving a cellulose ester, particularly capable of dissolving both cellulose triacetates and cellulose diacetates. The dissolution solvent should be added in sufficient quantities so as to effectively dissolve both the CTA and CDA, thereby forming the blended cellulose acetate dope.

In one embodiment or in combination with any other mentioned embodiments, the dissolution solvent can comprise at least one alkyl amide compound. An alkyl amide solvent is a solvent containing an alkyl group and a nitrogen molecule. An alkyl group can be either acyclic or cyclic (i.e., a cycloalkyl). An “acyclic alkyl group” may be defined as CₙH₂ₙ₊₁. A methyl group (CH₃) is the smallest acyclic alkyl functional group. A cycloalkyl may be formed by the removal of a hydrogen atom from a ring structure and contains the general formula CₙH₂ₙ₋₁. An amide is an organic compound with the general formula RC(═O)NR′R″. An alkyl amide substitutes hydrogen or an alkyl group or groups in place of the R, R′, and R″ groups.

In yet other embodiments, the dissolution solvent can comprise dimethylacetamide, dimethylformamide, formamide, N-formylmorpholine, N-methyl-2-pyrrolidone, N-methylformamide, 2-pyrrolidone, tetramethylurea, N-vinylacetamide, or N-vinylpyrrolidone, or combinations thereof. In certain embodiments, the dissolution solvent can comprise dimethylacetamide, dimethylformamide, or combinations thereof.

In one embodiment or in combination with any other mentioned embodiments, the BCA dope may contain trace amounts of, or alternatively, substantially no amount of methylene chloride, acetone, an ionic liquid, N-methylmorpholine N-oxide (NMMO), a tertiary amine oxide, a metal oxide precursor, acetic acid, a dihydric alcohol, or a combination thereof. In certain embodiments, the cellulose ester dope may contain less than 10, less than 9, less than 8, less than 7, less than 6, less than 5, less than 4, less than 3, less than 2, less than 1, less than 0.5, less than 0.1, less than 0.05, or less than 0.01 weight percent of methylene chloride, acetone, an ionic liquid, N-methylmorpholine N-oxide (NMMO), a tertiary amine oxide, a metal oxide precursor, acetic acid, a dihydric alcohol, or a combination thereof, based on the total weight of the BCA dope.

In one embodiment or in combination with any other mention embodiments, the BCA dope can comprise a solids content of at least 20, at least 21, at least 22, at least 23, or at least 24 weight percent and not more than 35, not more than 34, not more than 33, not more than 32, not more than 31, not more than 30, or not more than 29 weight percent, based on the total weight of the dope. For example, the BCA dope can comprise a solids content in the range of 20 to 35, 21 to 34, 22 to 33, 23 to 32, 24 to 31, 24 to 30, or 24 to 29 weight percent, based on the total weight of the dope.

Due to the type of cellulose acetates and dissolution solvents that are used, the BCA dope may exhibit desirable operating viscosities. In one embodiment or in combination with any other mentioned embodiments, the BCA dope may exhibit a viscosity of at least 10, at least 20, at least 30, at least 40, at least 50, at least 60, at least 70, at least 80, at least 90, or at least 100 and/or not more than 2,000, not more than 1,500, not more than 1,000, not more than 950, not more than 900, not more than 850, not more than 800, not more than 750, not more than 700, not more than 650, not more than 600, not more than 550, or not more than 500 poise at the spinning temperature utilized. Alternatively, the viscosity of the spinning dope can have any of these values when a sample of the dope composition used for spinning is taken and measured at 100° C. or 110° C. It should be noted that this “when measured” standard does not require the BCA dope to be utilized only at this designated temperature; rather, this temperature standard simply provides a temperature threshold at which to measure the viscosity of the BCA dope. Thus, the “when measured” threshold does not in any manner reflect the use or practice of the actual BCA dope. The viscosity defined herein is the “zero” shear viscosity obtained by extrapolating to a very low shear rate when viscosity is plotted versus shear rate, or alternately by using a Brookfield viscometer at low spindle RPM.

In one embodiment or in combination with any other mentioned embodiments, the BCA dope may exhibit a viscosity less than the viscosity of a comparable dope consisting of CTA only. The comparable dope having the same weight percent solids based on the total weight of the dope, having the same dissolution solvent, and having no CDA blended with the CTA will exhibit a higher viscosity and/or poorer dope processability than the blended dope of the present invention.

In one embodiment or in combination with any other mentioned embodiments, the BCA dope may comprise some or no additives in addition to the cellulose acetates. Such additives can include, but are not limited to, plasticizers, antioxidants, thermal stabilizers, pro-oxidants, acid scavengers, inorganics, pigments, colorants, delustrants, or combinations thereof.

FIG. 1 depicts an exemplary wet spinning system for producing the blended cellulose acetate fibers. It should be understood that FIG. 1 depicts one exemplary embodiment of the present technology. Thus, certain features depicted in FIG. 1 may be omitted and/or additional features described elsewhere herein may be added to the system depicted in FIG. 1. In embodiments, the features may be arranged in a different order than the system depicted in FIG. 1.

The wet spinning system depicted in FIG. 1 and described herein may produce a blended cellulose acetate fiber from a blended cellulose acetate dope, the properties and characteristics of both disclosed herein (above). The various characteristics and properties of the wet spinning process are disclosed below and it should be noted that, while all of the following characteristics and properties may be listed separately, it is envisioned that each of the following characteristics and/or properties of the wet spinning process, blended cellulose acetate dope, and blended cellulose acetate fibers are not mutually exclusive and may be combined and present in any combination.

Turning to FIG. 1, at least two cellulose acetate constituents, one CTA and one CDA, and at least one dissolution solvent may be introduced into a dope mixer 10 so as to form the blended cellulose acetate dope. The dope mixer 10 can comprise any conventional device capable of mixing the cellulose acetate and the dissolution solvent. Exemplary dope mixers 10 can include a continuous stirred tank reactor (“CSTR”). While in the dope mixer 10, the cellulose acetates and dissolution solvent can be subjected to temperature and mixing conditions that facilitate the dissolution of the cellulose acetates into the dissolution solvent, thereby forming the blended cellulose acetate dope. For example, it is known in the art that some cellulose ester dopes can be prepared by first cooling the mixture to a lower temperature to allow the solvent to better intermix with the polymer, before heating up to a final mixing temperature. Alternatively, some dope preparation processes prefer faster “flash” type heating to rapidly bring the system into solution with minimal degradation.

The dissolution solvent added to the dope mixer 10 can include one or more solvents capable of dissolving a cellulose ester such as those listed above, particularly capable of dissolving both cellulose triacetates and cellulose diacetates. The dissolution solvent should be added in sufficient quantities so as to effectively dissolve both the CTA and CDA, thereby forming the blended cellulose acetate dope. The BCA dope may comprise some or no additives in addition to the cellulose acetates. Such additives can include, but are not limited to, plasticizers, antioxidants, thermal stabilizers, pro-oxidants, acid scavengers, inorganics, pigments, colorants, delustrants, or combinations thereof.

Turning back to FIG. 1, after forming the BCA dope in the dope mixer 10, the newly formed BCA dope may be routed to an optional dope holding tank 20 for temporary storage and/or deaeration. The dope holding tank 20 can comprise any conventional storage tank known in the art that is capable of storing the dope. While stored in the holding tank 20, the BCA dope may be subjected to conditions facilitated to maintain the physical characteristics of the dope and/or remove gas bubbles introduced during the mixing step. For example, storing the dope at cold temperatures for too long will lead to unacceptable gelation that will adversely affect spinnability. This is particularly true as dope solids level is increased to higher levels. Thus, the temperature and pressure of the holding and/or deaeration tank 20 may be optimized as necessary to enhance and maintain the quality of the BCA dope.

Next, as shown in FIG. 1, the BCA dope can be pumped out of the dope holding tank 20, via a gear pump 30 or by any pumping means commonly known in the art for providing uniform flow, into a filter 40, which may remove any large and undesirable particulates and gels from the BCA dope prior to spinning. Furthermore, by keeping the dope viscosity lower, the filtration efficiency can be greatly increased. The filter 40 can comprise any conventional filter apparatus and filter type known in the art to be sufficient for removing insoluble and/or gel particles from viscous dope solutions. After passing through the filter 40, the filtered BCA dope may be pumped to the spinneret 51 positioned in the first coagulation bath 50.

As shown in FIG. 1, the BCA dope may be metered through the spinneret 51 to thereby form one or more BCA fibers 52 that coagulate in the first coagulation bath 50. Furthermore, the resulting fibers 52 are spin-drawn as coagulation takes place in the first coagulation bath 50. As shown in FIG. 1, the process for forming the BCA fibers 52 is a wet spinning process. A wet spinning process is a process which spins fibers 52 by metering the dope through a spinneret 51 which has face surface having one or more holes. The spinneret face is submerged in the liquid within the first coagulation bath 50. The shape and size of the hole or holes in the face of spinneret 51 help determine the cross section of the fibers 52. The number of holes in the spinneret face determines the number of fibers 52 simultaneously formed as dope is metered through the spinneret 51. As the dope passes through the holes in the spinneret face, the individual fibers 52 form in the first coagulation bath 50.

More particularly, in one embodiment or in combination with any other mentioned embodiments, the BCA dope can be spun at a rate of about 1 to 500 m/min through spinneret holes having a hole area equivalent to a circular diameter of 20 to 200 microns. In one embodiment or in combination with any other mentioned embodiments, the spinneret 51 may be maintained at a temperature of at least 5, at least 10, at least 15, at least 20, at least 25, at least 30, at least 35, or at least 40° C. and/or not more than 200, not more than 180, not more than 160, not more than 140, not more than 120, not more than 110, not more than 100, not more than 90, not more than 80, not more than 70, not more than 60, or not more than 50° C. In certain embodiments, the head of the spinneret 51 may be maintained at a temperature in the range of 50 to 200° C., 50 to 150° C., 50 to 100° C., 50 to 90° C., 50 to 80° C., 50 to 70° C., or 50 to 60° C.

In one embodiment or in combination with any other mentioned embodiments, based on the degree of polymerization and/or the molecular weight of the cellulose acetate constituents forming the blended cellulose acetate dope, the BCA dope may exhibit a viscosity, prior to or as fed into the spinneret 51, of at least 10, at least 20, at least 30, at least 40, at least 50, at least 60, at least 70, at least 80, at least 90, or at least 100 and/or not more than 2,000, not more than 1,500, not more than 1,000, not more than 950, not more than 900, not more than 850, not more than 800, not more than 750, not more than 700, not more than 650, not more than 600, not more than 550, or not more than 500 poise at spinning temperature. This spinning temperature is nominally the temperature of the dope as it passes through and into the spinneret. As noted above, the viscosity defined herein is the “zero” shear viscosity obtained by extrapolating to a very low shear rate when viscosity is plotted versus shear rate, or alternately by using a Brookfield viscometer at low spindle RPM.

In one embodiment or in combination with any other mentioned embodiments, the cellulose acetate constituents can have a number average degree of polymerization of at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, or at least 265. Additionally or alternatively, in one embodiment or in combination with any other mentioned embodiments, the cellulose acetate constituents can have a number average degree of polymerization of not more than 1,000, not more than 900, not more than 800, not more than 700, not more than 600, not more than 500, not more than 400, not more than 350, not more than 325, not more than 300, not more than 290, not more than 280, not more than 270, not more than 260, not more than 250, not more than 240, not more than 230, not more than 220, not more than 210, not more than 200, not more than 190, not more than 180, not more than 170, not more than 160, not more than 150, not more than 149, not more than 148, not more than 147, not more than 146, not more than 145, not more than 144, not more than 143, not more than 142, not more than 141, not more than 140, not more than 139, not more than 138, not more than 137, not more than 136, not more than 135, not more than 134, not more than 133, not more than 132, not more than 131, not more than 130, not more than 129, not more than 128, not more than 127, not more than 126, not more than 125, not more than 124, not more than 123, not more than 122, not more than 121, not more than 120, not more than 119, not more than 118, not more than 117, not more than 116, or not more than 115. In certain embodiments, the cellulose acetate constituents can have a number average degree of polymerization in the range of 10 to 1,000, 20 to 500, 30 to 400, 50 to 300, 60 to 250, 60 to 200, 60 to 150, 60 to 135, 70 to 200, 70 to 150, 70 to 135, 80 to 180, 80 to 150, 80 to 145, 80 to 140, 80 to 135, or 90 to 130.

In one embodiment or in combination with any other mentioned embodiments, the cellulose acetate constituents can comprise a weight-average absolute molecular weight of at least 50,000, at least 55,000, at least 60,000, at least 65,000, at least 70,000, at least 75,000, at least 80,000, or at least 85,000 and/or not more than 150,000, not more than 140,000, not more than 130,000, not more than 120,000, not more than 110,000, not more than 100,000, or not more than 95,000 as measured by absolute molecular weight via GPC. In certain embodiments, the cellulose ester can comprise a weight-average absolute molecular weight in the range of 50,000 to 150,000, 70,000 to 120,000, or 80,000 to 95,000 as measured by absolute molecular weight via GPC.

In one embodiment or in combination with any of the mentioned embodiments, the cellulose acetate constituents can have any of the above-mentioned weight average absolute molecular weights as measured under ASTM D6474.

At the spinneret 51, the BCA dope can be extruded through a plurality of holes to form continuous blended cellulose acetate fibers 52. At the spinneret 51 and within the first coagulation bath 50, BCA fibers 52 may be drawn to form bundles of several hundred, or even thousand, individual fibers 52 within the first coagulation bath 50. Each of these bundles may include at least 10, at least 20, at least 30, at least 40, at least 50, at least 60, at least 70, at least 80, at least 90, at least 100, at least 150, at least 200, at least 250, at least 300, at least 350, or at least 400 and/or not more than 100,000, not more than 50,000, not more than 10,000, not more than 1,000, not more than 900, not more than 800, not more than 700, or not more than 600 fibers. The spinneret 51 may be operated at any speed suitable to produce individual filament fibers 52 having the desired size and shape. As used herein, the term “individual filament fiber” refers to the continuous filament that is initially produced by the spinneret 51.

In one embodiment or in combination with any other mentioned embodiments, the BCA fibers 52 are spin-drawn in the first coagulation bath 50 at a jet draw stretching ratio (“JDSR”) ranging from 0.75:1 up to 1.5:1. More particularly, in one embodiment or in combination with any other mentioned embodiments, the BCA fibers may be stretched at a JDSR of at least 0.75:1 or at least 1:1 and/or not more than 1.5:1, not more than 1.4:1, not more than 1.3:1, not more than 1.2:1, not more than 1.1:1. In certain embodiments, the cellulose ester fibers may be spin-drawn at a spin-draw ratio in the range of 0.75:1 to 1.5; 0.75:1 to 1.4:1, 0.75:1 to 1.3:1, 0.75:1 to 1.2:1, 0.75:1 to 1.1:1, 1:1 to 1.5; 1:1 to 1.4:1, 1:1 to 1.3:1, 1:1 to 1.2:1, 1:1 to 1.1:1.

The JDSR is a ratio of the velocity of the fiber at the first set of driven take-up roll (or pair of rolls) 53 that pull or “draw” the coagulating BCA fibers through the first coagulation bath 50 to the velocity of the BCA dope as it exits the holes in the face of the spinneret 51. A JDSR of 1.5:1 indicates that the velocity of the BCA fiber at the take-up roll 53 is 1.5 times the velocity of the BCA dope as it leaves the spinneret face. Similarly, a JSSR of 0.75:1 indicates the fiber velocity at the take-up roll 53 is 0.75 times that of the BCA dope velocity as it leaves the spinneret face. The velocity of the BCA dope as it leaves the face of the spinneret is calculated by dividing the mass flow rate of the BCA dope metered to the spinneret (g/min) by the number of holes in the face of the spinneret then dividing that (g/min/filament) value by density of the BCA dope in g/cm³ and dividing the resulting volumetric flow rate cm³/min/filament value by the cross sectional area (cm²) of the individual hole in the face of the spinneret to determine velocity (cm/min) of the spinning dope as it exits the spinneret die. The velocity of the fiber at the take-up roll 53 is calculated by multiplying the circumference (π*diameter, in cm) of the take-up roll 53 by the revolutions per minute of the roll to arrive at a velocity in cm/min.

As noted above, jet draw stretching may occur in the first coagulation bath 50. Thus, in such embodiments, subsequent coagulation or wash baths do not serve as locations for spin-drawing. Any stretching of the fibers due to higher surface velocities of rolls at the end of a bath or baths as compared to the surface velocities of rolls feeding into the bath or baths may be considered post draw stretching, but this is a separate operation from jet draw stretching which takes place before the crystalline structure of the polymeric fiber has developed.

The first coagulation bath 50 comprises either:
a) Water;
b) Water and a dope solvent;
c) Water and one or more anti-solvent coagulants; or
d) Water, dope solvent, and one or more anti-solvent coagulants.

If a coagulation solvent is employed, it may be an aqueous coagulation solvent containing water. Water, alcohols, and glycols are considered to be suitable anti-solvent coagulants. The total amount of water from all sources contained in the coagulation bath 50 may be at least 40, at least 45, at least 50, at least 55, at least 60, at least 65, at least 70, at least 75, at least 80, at least 85, at least 90, at least 95, at least 99, or 100 weight percent of water, based on the total weight of all liquids in the coagulation bath. Additionally or alternatively, In one embodiment or in combination with any other mentioned embodiments, the amount of water in the coagulation bath 50 may be no more than 100, no more than 99, no more than 90, no more than 80, no more than 70, no more than 60 weight percent of water, based on the total weight of liquids in the coagulation bath. In certain embodiments, the coagulation bath can contain 60 to 90, 50 to 95, or 40 to 100 weight percent water, based on the total weight of the liquids in the coagulation bath 50. When present in the coagulation bath 50, the total amount of dope solvent present can be at least 0.1, at least 0.5, at least 1.0, or at least 5.0 percent by weight based on the weight of all liquids in the coagulation bath. Additionally or in the alternative, the total amount of dope solvent in the coagulation bath 50 can be not more than 60, not more than 55, not more than 50, not more than 45, not more than 40, not more than 35, not more than 30, not more than 25, not more than 20, or not more than 10 percent by weight based on the weight of all liquids in the coagulation bath 50. Suitable ranges of dope solvent in the coagulation bath 50 include 0.0 to 60, 0.1 to 50, or 0.5 to 45, or 1 to 45, or 1 to 35, or 1 to 25, or 1 to 15, or 1 to 10 weight percent based on the weight of all liquids in the coagulation bath 50. The dope solvent in the coagulation bath 50 can be obtained as fresh dope solvent added to the coagulation bath or obtained from washing or exuding residual dope solvent off the fiber as it is drawn through the coagulation bath 50, or both. The dope solvent can be at least one of the same solvents used in the dope composition to dissolve the cellulose ester polymer before spinning. In one embodiment or in combination with any other mentioned embodiments, the coagulation bath 50 contains dope solvent solely obtained from residual dope solvent on or in the fiber. In one embodiment or in combination with any other mentioned embodiments, the dope solvent in the coagulation bath 50 is obtained both from the residual dope solvent in or on the fiber and with addition of fresh make-up dope solvent to the coagulation bath 50.

Suitable dope solvents include at least one alkyl amide compound. Examples of suitable alkyl amide compound solvents include dimethylacetamide, dimethylformamide, formamide, N-formylmorpholine, N-methyl-2-pyrrolidone, N-methylformamide, 2-pyrrolidone, tetramethylurea, N-vinylacetamide, or N-vinylpyrrolidone, or combinations thereof. In certain embodiments, the additional solvent can comprise dimethylacetamide, dimethylformamide, or combinations thereof.

In one embodiment or in combination with any other mentioned embodiments, the coagulation solvent may contain trace amounts of, or alternatively, substantially no amount of methylene chloride, acetone, an ionic liquid, N-methylmorpholine N-oxide (NMMO), a tertiary amine oxide, a metal oxide precursor, acetic acid, a dihydric alcohol, or a combination thereof. In certain embodiments, the coagulation solvent may contain less than 10, less than 9, less than 8, less than 7, less than 6, less than 5, less than 4, less than 3, less than 2, less than 1, less than 0.5, less than 0.1, less than 0.05, or less than 0.01 weight percent of methylene chloride, acetone, an ionic liquid, N-methylmorpholine N-oxide (NMMO), a tertiary amine oxide, a metal oxide precursor, acetic acid, a dihydric alcohol, or a combination thereof, based on the total weight of the solvents in the coagulation bath.

Additionally or alternatively, in one embodiment or in combination with any other mentioned embodiments, the first coagulation bath 50, including the liquid therein, may be maintained at a temperature of at least 5, at least 10, or at least 15° C. and/or not more than 25, not more than 22, or not more than 20° C. In certain embodiments, the first coagulation bath 50, including the coagulation solvent therein, may be maintained at a temperature in the range of 5 to 25° C., 5 to 22° C., or 10 to 20° C.

It should be noted that the BCA fibers 52 formed in the first coagulation bath 50 may be in the form of monocomponent fibers that are formed from only one material (e.g., the BCA dope) or a uniformly blended composition and, therefore, would not be considered “bicomponent” or “multicomponent fibers,” which are characterized by internal phases or boundaries delineating different compositions within the external surface of the fiber. In one embodiment or in combination with any other mentioned embodiments, the resulting BCA fibers can comprise at least 50, at least 55, at least 60, at least 65, at least 70, at least 75, at least 80, at least 85, at least 90, at least 95, at least 99, or at least 99.9 weight percent cellulose acetate, based on the total weight of the fiber. In certain embodiments, the BCA fiber can be formed entirely from the cellulose acetate constituents.

The individual BCA fibers 52 discharged from the spinneret 51, may have any suitable transverse cross-sectional shape. Exemplary cross-sectional shapes include, but are not limited to, round, kidney bean, ribbon, crenulated, multi-lobal, or other than round (non-round). It is well known in the art that the shape of the cross-section is typically determined by the balance of coagulation diffusion into the fiber relative to the rate of diffusion of solvent out of the fiber in the coagulation bath. When these are balanced, the fiber remains more nearly circular. Adjusting bath temperature and/or solvent level, for example, can be used to make fiber more or less circular in shape, or alternately more of a kidney bean or ribbon/lobed type shape.

In one embodiment or in combination with any other mentioned embodiments, the individual fibers 52 discharged from the spinneret 51 may have a substantially round cross-sectional shape. As used herein, the term “cross-section” generally refers to the transverse cross-section of the fiber measured in a direction perpendicular to the direction of elongation of the fiber. The cross-sectional area and perimeter of the fiber may be determined and measured using Quantitative Image Analysis (“QIA”).

The cross-sectional shape of an individual fiber may also be characterized according to its deviation from a round cross-sectional shape. In some cases, this deviation can be characterized by the shape factor of the fiber, which is determined by the following formula: Shape Factor=Perimeter/((4π×Cross-Sectional Area)^{1/2}). In some embodiments, the shape factor of the individual BCA fibers can be from 1 to 2, 1 to 1.8, 1 to 1.7, 1 to 1.5, 1 to 1.4, 1 to 1.25, 1 to 1.15, or 1 to 1.1. The shape factor of a fiber having a perfect round cross-sectional shape is 1. The shape factor can be calculated from the cross-sectional area and perimeter of the fiber, both of which can be measured using QIA.

Furthermore, in certain embodiments, the BCA fibers 52 may be in the form of solid fibers (fibers having a solid cross-sectional shape without an aperture present therein) and not in the form of hollow fibers.

As discussed above, the tenacity and elongation are properties that help determine the suitability of the BCA fibers 52 in downstream applications. In one embodiment or in combination with any other mentioned embodiments, the BCA fibers and/or the yarn produced therefrom may exhibit a tenacity of at least 1.6. at least 1.7, at least 1.8, at least 1.9, at least 2.0, at least 2.1, at least 2.2, at least 2.3, at least 2.4, or at least 2.5 g/denier as measured according to ASTM D22556. In one embodiment or in combination with any other mentioned embodiments, the BCA fibers and/or the yarn produced therefrom may exhibit an elongation at break of at least 15, at least 16, at least 17, at least 18, at least 19, at least 20, at least 21, at least 22, at least 23, at least 24, at least 25, at least 26, at least 27, at least 28, at least 29, or at least 30 percent as measured according to ASTM D22556. In one embodiment or in combination with any other mentioned embodiments, the BCA fibers and/or the yarn produced therefrom may exhibit a silk factor of at least 7.6, at least 7.7, at least 7.8, at least 7.9 or at least 8.0, where elongation is expressed in percent and tenacity is in grams/denier.

As noted above, the BCA fibers 52 are formed as continuous filament fibers. Thus, in one embodiment or in combination with any other mentioned embodiments, the BCA fibers may have an aspect ratio (L/D) of at least 10:1, at least 20:1, at least 30:1, at least 40:1, at least 50:1, at least 100:1, at least 500:1, at least 1,000:1, or at least 10,000:1. The finished fiber may be a continuous fiber or it may be cut to form staple fibers.

As shown in FIG. 1, the newly-formed BCA fibers 52 may be wrapped around take-up roll 53 which provides tension and pulls the BCA fibers out of the bath 50 and feeding the downstream steps of the process, which may include, for example, one or more additional coagulation baths, one or more wash baths, one or more drafting drawing sections, one or more drying sections, one or more annealing sections, a winder, a crimper, a cutter, or combinations thereof.

Turning back to FIG. 1, in one embodiment or in combination with any other mentioned embodiments, the BCA fibers 52 formed in the first coagulation bath 50 may be gathered into a bundle, band, or yarn 54. The bundle, band, or yarn 54 may comprise a plurality of the BCA fibers 52. Each of these bundles, bands, or yarns may include at least 10, at least 20, at least 30, at least 40, at least 50, at least 60, at least 70, at least 80, at least 90, at least 100, at least 150, at least 200, at least 250, at least 300, at least 350, or at least 400 and/or not more than 100,000, not more than 50,000, not more than 10,000, not more than 5,000, not more than 1,000, not more than 900, not more than 800, not more than 700, or not more than 600 individual fibers.

Subsequently, as shown in FIG. 1, in one embodiment or in combination with any other mentioned embodiments, the bundle, band, or yarn 54 may be introduced into a drawing section 60 in order to be subjected to additional drawing or post draw stretching. This latter drawing or post draw stretching is differentiated from jet draw stretching in that post draw stretching occurs after the first coagulation bath take up roll(s) 53, therefore the fiber has already undergone some coagulation and crystallization. Because post draw stretching of the fiber is applied after the material is already partially solidified, it tends to cause more microscale damage to the fiber if done excessively. Hence, this additional stretching can boost tenacity, but typically also causes a significant decrease in elongation.

While in the drawing section 60, the bundle, band, or yarn may be subjected to additional stretching so as to further modify the length and width of the yarn and modify the polymer orientation within the individual fibers. The drawing process may involve passing the bundle, band, or yarn 54 through several driven or speed-controlled draw rolls or pairs of draw rolls, which may have heat applied to improve the ductility of the filaments. Elevating the temperature of the bundle, band, or yarn 54 may also be accomplished by passing the bundle, band, or yarn 54 through a hot water bath or a steam box or stream of hot air in order to sufficiently soften the filaments for stretching. Generally, each successive draw roll or pair of draw rolls rotates at a higher speed than the preceding draw roll or pair of draw rolls so that the bundle, band, or yarn 54 is subjected to stretching, which may impart additional crystallinity and reduced denier per filament as the filaments are substantially stretched as they pass through the drawing frame. As shown in FIG. 1, the bundle, band, or yarn 54 is first taken up by a slow draw roll or pair of draw rolls 61 and then a fast draw roll or pair of draw rolls 62.

In one embodiment or in combination with any other mentioned embodiments, after having been subjected to further stretching in the drawing section 60 or alternatively, without stretching or drawing in drawing section 60, the drawn fiber or yarn may then be introduced into one or more additional coagulation baths 70 and/or one or more wash tanks 80 in order to remove the residual coagulation and dissolution solvents and other undesirable impurities. These additional coagulation baths typically contain the same solvents and operating conditions as the first coagulation bath 50, but usually involve a lower solvent level than the first coagulation bath 50. Alternatively, it is possible to exclude the additional coagulation baths in certain embodiments and replace such additional baths with one or more additional wash tanks. The wash tanks may contain pure water at various temperatures to facilitate the removal of residual solvent from the fiber. This can also include the use of water sprayed onto the fibers. Wash temperatures typically range from about room temperature up to 99° C., although it has been observed that higher wash temperatures tend to alter the fibers. Thus, it may be desirable to utilize a wash temperature of less than 90° C., or more desirably less than 75° C.

In one embodiment or in combination with any other mentioned embodiments, after leaving the wash tank 80, the washed fiber or yarn may then be subjected to drying and optional annealing in the dryer 90. This dryer 90 may comprise any conventional drying oven known in the art. Generally, annealing is a process comprising: (i) heating the fiber up to a temperature greater than half of its melting point, (ii) holding the fiber at that temperature for a period of time, and (iii) subsequently cooling the fiber in a manner that reduces internal stress within the fiber.

In one embodiment or in combination with any other mentioned embodiments, after exiting the dryer 90, the dried fiber, bundle, band, or yarn may then be accumulated onto cores or tubes at the winder 100 and may be sent to optional downstream processes.

Although not depicted in FIG. 1, the wet spinning process may, in certain embodiments, have in place before or after the winder 100 one or more crimping zones to thereby at least partially crimp the BCA fiber, bundle, band, or yarn. In one embodiment or in combination with any other mentioned embodiments, the BCA fiber, bundle, band, or yarn may be crimped. Alternatively, in certain embodiments, the BCA fiber, bundle, band, or yarn is not crimped.

The BCA fibers, bundle, band, or yarn may be passed through a crimping zone wherein a patterned wavelike shape may be imparted to at least a portion, or substantially all, of the individual fibers. When used, the crimping zone includes at least one crimping device for mechanically crimping the fibers. Generally, the BCA fibers desirably are not crimped by thermal or chemical means (e.g., hot water baths, steam, air jets, or chemical coatings), but instead are mechanically crimped using a suitable crimper. One example of a suitable type of mechanical crimper is a “stuffing box” or “stuffer box” crimper that utilizes a plurality of rollers to generate friction, which causes the fibers to buckle and form crimps. Other types of crimpers may also be suitable. Examples of equipment suitable for imparting crimp fibers are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, each of which is incorporated herein by reference to the extent not inconsistent with the present disclosure.

In one embodiment or in combination with any other mentioned embodiments, crimping may be performed such that the BCA fibers have a crimp frequency of at least 5, at least 7, at least 10, at least 12, at least 13, at least 15, or at least 17 and/or up to 30, up to 27, up to 25, up to 23, up to 20, or up to 19 crimps per inch (“CPI”), as measured according to ASTM D3937-12. In certain embodiments, the average CPI of the fibers, bundle, band, or yarns and/or various downstream products may be in the range of 7 to 30 CPI, 10 to 30 CPI, 10 to 27 CPI, 10 to 25 CPI, 10 to 23 CPI, 10 to 20 CPI, 12 to 30 CPI, 12 to 27 CPI, 12 to 25 CPI, 12 to 23 CPI, 12 to CPI, 15 to 30, CPI, 15 to 27 CPI, 15 to 23 CPI, 15 to 20 CPI, or 15 to 19 CPI.

In one embodiment or in combination with any other mentioned embodiments, when crimped, the crimp amplitude of the BCA fibers may vary and can, for example, be at least 0.85, at least 0.90, at least 0.93, at least 0.96, at least 0.98, at least 1.00, or at least 1.04 mm. Additionally or alternatively, in one embodiment or in combination with any other mentioned embodiments, the crimp amplitude of the fibers can be up to 1.75, up to 1.70, up to 1.65, up to 1.55, up to 1.35, up to 1.28, up to 1.24, up to 1.15, up to 1.10, up to 1.03, or up to 0.98 mm.

Additionally, in one embodiment or in combination with any other mentioned embodiments, the BCA fibers, bundle, band, or yarn, and/or staple fibers produced therefrom may have a crimp ratio of at least 1:1. As used herein, “crimp ratio” refers to the ratio of the non-crimped tow length to the crimped tow length. In certain embodiments, the fibers, yarns, and/or staple fibers produced therefrom may have a crimp ratio of at least 1:1, at least 1.1:1, at least 1.125:1, at least 1.15:1, or at least 1.2:1.

Crimp amplitude and crimp ratio are measured according to the procedure outlined in U.S. Pat. App. Pub. No. 2020/0299882, which is incorporated herein by reference to the extent not inconsistent with the present disclosure.

Additionally, or alternatively, in one embodiment or in combination with any other mentioned embodiments, one or more types of surface finish or lubricants may be applied to the BCA fibers, bundle, band, or yarn formed therefrom. The method of application is not limited and can include the use of spraying, wick application, dipping, or use of squeeze rollers, lick rollers, or kiss rollers. The location for applying a finish to a fiber can vary depending on the function of the finish. For example, the lubricant finish can be applied after spinning and before crimping, or before gathering the fibers into a bundle. Cutting lubricants and/or antistatic lubricants can be applied before or after crimping and prior to drying. Suitable amounts of all finishes (whether lubricant, cutting lubricant, antistatic electricity finish, or otherwise) on the BCA fibers can be at least 0.01, at least 0.02, at least 0.05, at least 0.10, at least 0.15, at least 0.20, at least 0.25, at least 0.30, at least 0.35, at least 0.40, at least 0.45, at least 0.50, at least 0.55, or at least 0.60 percent finish-on-yarn (“FOY”) relative to the weight of the dried fiber. Additionally or alternatively, in one embodiment or in combination with any other mentioned embodiments, the cumulative amount of finish may be present in an amount of not more than 2.5, not more than 2.0, not more than 1.5, not more than 1.2, not more than 1.0, not more than 0.9, not more than 0.8, or not more than 0.7 weight percent FOY based on the total weight of the dried fiber. The amount of finish on the fibers as expressed by weight percent may be determined by solvent extraction. As used herein “FOY” or “finish on yarn” refers to the amount of finish on the fiber or yarn less any added water.

In one embodiment or in combination with any other mentioned embodiments, the BCA fibers can include at least one plasticizer or, in the alternative, no plasticizer. The BCA fibers may comprise less than 15, less than 12, less than 10, less than 9, less than 8, less than 7, less than 6, less than 5, less than 4, less than 3, less than 2, less than 1, less than 0.5, less than 0.1, less than 0.05, less than 0.01, less than 0.005, less than 0.001, or less than 0.0007 weight percent of at least one plasticizer, based on the total weight of the fiber. When present, the plasticizer may be incorporated into the fiber itself by spinning a dope containing a plasticizer, contained in a flake used to make the dope, and/or the plasticizer may be applied to the surface of the fiber or filament by any of the methods used to apply a finish. If desired, the plasticizer can be contained in the finish formulation.

The resulting BCA fibers may be used to produce a vast array of end products, such as tow band, staple fibers, filament yarns, spun yarns, woven articles, nonwoven articles, and/or knitted textiles.

In one embodiment or in combination with any other mentioned embodiments, the BCA fibers and/or yarns described above may be cut into staple fibers. Any suitable type of cutting device that is capable of cutting the fibers to a desired length without excessively damaging the fibers may be used. Examples of cutting devices can include, but are not limited to, rotary cutters, guillotines, stretch breaking devices, reciprocating blades, or combinations thereof. Once cut, the BCA staple fibers may be baled or otherwise bagged or packaged for subsequent transportation, storage, and/or use. In one embodiment or in combination with any other mentioned embodiments, the d50 length of the staple fibers may be at least 5, at least 10, at least 20, at least 30, at least 40, or at least 50 mm and/or not more than 150, not more than 140, not more than 130, not more than 125, not more than 120, not more than 115, not more than 110, not more than 105, not more than 100, or not more than 95 mm.

Additionally or alternatively, in one embodiment or in combination with any other mentioned embodiments, the denier per filament (weight in g of 9000 m fiber length), or “DPF,” of the BCA fibers (whether staple fibers or continuous fibers) may be within a range of 0.5 to less than 20. The particular method for measurement is not limited and includes the ASTM 1577-07 method using the FAVIMAT vibroscope, a microbalance weight measurement of a sample of known length, or a width analysis using any convenient optical microscopy or analyzer. The DPF can also be correlated to the maximum width of a fiber.

Additionally or alternatively, in one embodiment or in combination with any other mentioned embodiments, the individual BCA fibers and/or the staple fibers produced therefrom may comprise an average width of at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, or at least 20 microns and/or not more than 300, not more than 200, not more than 150, not more than 100, not more than 90, not more than 80, not more than 70, not more than 60, not more than 50, not more than 40, not more than 30, or not more than 25 microns. In certain embodiments, the individual BCA fibers and/or the staple fibers produced therefrom may comprise an average width in the range of 1 to 300, 2 to 200, 3 to 100, 4 to 70, 5 to 50, or 8 to 30 microns.

In one embodiment or in combination with any other mentioned embodiments, the staple fibers of the present invention can be formed into a blended cellulose acetate spun yarn. Spun yarns are continuous strands comprising short staple fibers which are mechanically entangled by a staple yarn spinning process. Staple yarn spinning processes can be, but are not limited to, ring spinning, open-end spinning, air jet spinning, compact spinning, siro spinning, vortex spinning, worsted spinning, semi-worsted spinning, woolen spinning, and wet spinning with flax.

In one embodiment or in combination with any other mentioned embodiments, the BCA fibers may be formed into a nonwoven article, such as a nonwoven textile. Exemplary nonwoven articles can include wet-laid nonwoven articles, air-laid non-woven articles, carded articles, and/or dry-laid non-woven articles.

In one embodiment or in combination with any other mentioned embodiments, the BCA yarns may be formed into a woven article, such as a woven textile. Woven textiles can be formed on a loom by interlacing at least two yarns, a warp yarn, and a weft yarn, wherein the warp yarn strands are oriented in parallel and the weft yarns are interlaced at an angle to the orientation of the warp yarns in an alternating pattern over and under the warp yarns.

In one embodiment or in combination with any other mentioned embodiments, the BCA yarns may be formed into a knitted article, such as a knitted textile. Such knitted textiles may be formed by interlocking loops of yarn.

In one embodiment or in combination with any other mentioned embodiments, the end products described herein, including the staple fibers, yarns, nonwoven articles, knitted articles, and the woven articles, may comprise, consist essentially of, or consist of the BCA fibers. The end products described herein, including the staple fibers, yarns, nonwoven articles, knitted articles, and the woven articles, may comprise at least 0.25, at least 0.5, at least 0.75, at least 1, at least 2, at least 3, at least 4, at least 5, at least 6, at least 7, at least 8, at least 9, at least 10, at least 12, at least 15, at least 18, at least 20, at least 25, at least 30, at least 35, at least 40, at least 45, at least 50, at least 55, at least 60, at least 65, at least 70, at least 75, at least 80, at least 85, at least 90, at least 95, at least 99, or at least 99.9 weight percent of one or more BCA fibers, based on the total weight of the article. Additionally or alternatively, in one embodiment or in combination with any other mentioned embodiments, the end products described herein, including the staple fibers, yarns, nonwoven articles, knitted articles, and the woven articles, may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 9, not more than 8, not more than 7, not more than 6, or not more than 5 weight percent of one or more BCA fibers, based on the total weight of the article. In certain embodiments, the end products may be formed entirely from the BCA fibers or comprise in the range of 0.25 to 50, 1 to 99, 1 to 50, 50 to 99, 1 to 20, or 0.25 to 5 weight percent of one or more cellulose ester fibers, based on the total weight of the article.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” “comprise,” “contain,” “containing,” and “contains” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

Additionally, it should be understood that a listing of numerical values following a descriptor, such as “at least” and “not more than,” provides literal support for a range based on all of the numerical values following that descriptor. For example, a statement specifying “at least 2, 5, or 10 and/or not more than 100, 50, or 25” would provide literal support for ranges of “at least 25,” “not more than 50,” and “at least 10 and not more than 25.”

### EXAMPLES

The following examples are intended to be illustrative of the present invention in order to teach one of ordinary skill in the art to make and use the invention and are not intended to limit the scope of the invention in any way. As described below, several tests were performed on samples produced via the process described by the present invention as well as comparative process conditions.

Cellulose triacetate (CTA), cellulose diacetate (CDA), and blended cellulose acetate (BCA) dopes were prepared and wet spun into fiber according to the multifilament wet spinning method below. The resulting fibers were evaluated according to the Fiber Testing Protocol below. The ratios of CTA to CDA are shown in Table 1.

TABLE 1

| | Weight | Weight |
|---|---|---|
| Example | % CTA | % CDA |
| 1 - CTA (100/0) | 100 | 0 |
| 2 - CDA (0/100) | 0 | 100 |
| 3 - BCA (80/20) | 80 | 20 |
| 4 - BCA (70/30) | 70 | 30 |
| 5 - BCA (60/40) | 60 | 40 |
| 6 - BCA (40/60) | 40 | 60 |
| 7 - BCA (20/80) | 20 | 80 |

### Multifilament Wet Spinning Method

Dope was prepared in a 500 ml three neck flask using cellulose triacetate (CTA) from Eastman Chemical Co., Kingsport TN (Eastman CTA VM 149) and cellulose diacetate (CDA) from Eastman Chemical Co. (Eastman CA-394-60). CTA, CDA, and CTA and CDA together were dissolved in dimethylacetamide (DMAc) with the total solids concentrations (including both CTA and CDA combined) ranging from 20 to 29 weight % based on the total weight of the dope. Dope density of 1.02 (±0.02) was targeted in order to achieve a pumpable dope viscosity. The dope was stirred at 400 rpm and 90° C. for 90 minutes, then stirred at 150 rpm for 30 minutes. The dope was then cooled down to 60° C. and degassed for 3 hours.

The degassed dope was transferred from the three-neck flask to a 50 mL stainless steel syringe with an attached spin pack comprising a multifilament spinneret and single layer of filter media having a nominal pore size of 8 microns to filter the dope as it was pumped to the spinneret. The syringe and spin pack apparatus were connected to a high-pressure syringe pump capable of precisely metering the spinning dope to control the dope flow rate to +/−1%. The spinneret face comprised 19 circular holes, each hole having a diameter measuring 0.045 mm (45 micron). The spinneret was submerged in the coagulation bath (an aqueous solution of water or water and dimethylacetamide). The dope was pumped through the spinneret at temperatures from 50° C. to 100° C. and extruded into the coagulation bath as 19 filaments. The filaments passed through the coagulation bath and were drawn out of the bath by a driven take up roll. The speed of the take up roll was controlled relative to the exit velocity of the filaments at the submerged spinneret face to determine the Jet Draw Spinning Ratio (JDSR). The fibers were accumulated onto a bobbin at the winding step and the speed of the winder was controlled relative to the speed of the take up roll to determine the Post Draw Spinning Ratio (PDSR). The Total Draw Ratio was determined by dividing the winder speed by the exit velocity of the filaments at the submerged spinneret face. The fibers on the bobbin were washed by immersion in deionized water for 10 minutes in an overflow water bath at room temperature. Following washing, the fiber was cut from the bobbin to form loose fibers which were dried in a convection oven for 15 minutes at 120° C.

Several process parameters of the wet-spinning method were evaluated as the fiber samples were produced. These parameters included coagulation bath temperature, concentration of DMAc in the coagulation bath length, jet draw stretching ratio, and post draw stretching ratio. Coagulation bath temperatures included 10° C. and 25° C.; coagulation bath DMAc concentrations included 0%, 25%, 45% and 65%; and coagulation baths of 6″ and 44″ lengths were evaluated. Based on the flow of dope from the spinneret and the take up roll speeds, the 6″ and 44″ baths yielded nominal residence times of approximately 0.9 seconds and 6.3 seconds respectively. JDSR were varied from 0.75:1 to 2:1; PDSR were varied from 1:1 to 1.67:1.

### Fiber Evaluation Protocol

The mechanical properties of the fibers were measured on a FAVIMAT instrument according to ASTM D1577-07 (2018) for denier and ASTM D3822/D3822M-14 (2020) for tenacity and elongation at break. Test conditions: 25 mm gauge length, 15 mm/min strain rate, 0.05 g/denier pre-tension). Silk Factor was calculated from the tenacity and elongation at break results. Sample results represent the averages of at least 10 mechanical property tests per sample.

The moisture pick-up of the fibers was measured according to ASTM D2654-22 Procedure 1 modified by drying the samples at 120° C. for 1 hour (rather than 105° C. until the weight loss decreased to not more than 0.01% over 2 hours).

### Example 1—(100/0)

100% CTA dopes were prepared at dope solids of 20 wt % and 22 wt % based on the total weight of the dope, then wet-spun into fiber samples according to the multifilament wet spinning method above. The spinning conditions yielding the optimal silk factors for 100% CTA fibers included 0% DMAc bath, bath residence time of about 1 second, no post draw, jet draw no greater than 1.2:1 and bath temperatures of 10° C. and 25° C. The three highest silk factor samples of 100% CTA fiber yielded an average silk factor of 8.10. The moisture pickup for the 100% CTA fiber averaged 2.69%. The data are shown in Table 2.

TABLE 2
Example 1 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 8.35 | 64.6 | 1.00 | 1.00 | 1 | 25 | 6 | 0 | 54 | 1.01 | 20 | 2.97 | 27.86 | 4.70 | 1.58 |
| 8.00 | 64.6 | 1.20 | 1.00 | 1.2 | 25 | 6 | 0 | 54 | 1.01 | 20 | 2.57 | 26.58 | 3.99 | 1.55 |
| 7.95 | 71.3 | 1.0 | 1.00 | 1.08 | 10 | 6 | 0 | 54 | 1.01 | 22 | 3.54 | 23.42 | 5.83 | 1.64 |

### Example 2—(0/100)

100% CDA dopes were prepared at dope solids of 29 wt % based on the total weight of the dope, then wet-spun into fiber samples according to the multifilament wet spinning method above. The spinning conditions yielding the optimal silk factors for 100% CDA fibers included 0% DMAc bath, bath residence time of about 1 second, no post draw, jet draw no greater than 1.2:1 and bath temperatures of 10° C. and 25° C. The three highest silk factor samples of 100% CDA fiber yielded an average silk factor of 6.97. The moisture pickup for the 100% CDA fiber averaged 4.57%. The data are shown in Table 3.

TABLE 3
Example 2 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 7.08 | 93.7 | 1.20 | 1.00 | 1.2 | 10 | 6 | 0 | 54 | 1.01 | 29 | 4.47 | 20.31 | 7.00 | 1.57 |
| 7.04 | 93.7 | 1.00 | 1.00 | 1 | 25 | 6 | 0 | 54 | 1.01 | 29 | 4.61 | 26.33 | 6.32 | 1.37 |
| 6.80 | 93.7 | 0.75 | 1.00 | 0.75 | 25 | 6 | 0 | 54 | 1.01 | 29 | 5.99 | 29.88 | 7.43 | 1.24 |

### Example 3—(80/20)

Blended Cellulose Acetate dopes were prepared at dope solids of 20 and 22 wt % based on the total weight of the dope. 80% of the solids was CTA and 20% was CDA, or 17.6 wt % CTA and 4.4 wt % CDA based on the total weight of the dope. The 80/20 blended dope was wet-spun into fiber samples according to the multifilament wet spinning method above. The spinning conditions yielding the optimal silk factors for the 80/20 BCA fibers included 45% DMAc bath, bath residence times of about 1 second and about 6 seconds, 1:1 and 1.22:1 post draws, total draw not less than 1.22, jet draw no less than 1:1 and bath temperatures of 10° C. and 25° C. The three highest silk factor samples of 80/20 BCA fiber yielded an average silk factor of 7.70. The moisture pickup for the 80/20 BCA fiber averaged 2.45%. Data are shown in Table 4.

TABLE 4
Example 3 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 8.02 | 71.3 | 1.50 | 1.00 | 1.5 | 10 | 44 | 45 | 60 | 1.01 | 22 | 2.07 | 20.59 | 3.66 | 1.77 |
| 7.62 | 64.6 | 1.20 | 1.00 | 1.2 | 25 | 6 | 45 | 54 | 1.01 | 20 | 3.42 | 27.05 | 5.00 | 1.47 |
| 7.47 | 71.3 | 1.80 | 1.00 | 1.8 | 10 | 44 | 45 | 60 | 1.01 | 22 | 1.79 | 17.59 | 3.18 | 1.78 |

### Example 4—(70/30)

Blended Cellulose Acetate dopes were prepared at dope solids of 24 wt % based on the total weight of the dope. 70% of the solids was CTA and 30% was CDA, or 16.8 wt % CTA and 7.2 wt % CDA based on the total weight of the dope. The 70/30 blended dope was wet-spun into fiber samples according to the multifilament wet spinning method above. The spinning conditions yielding the optimal silk factors for the 70/30 BCA fibers included 0% DMAc bath, bath residence times of about 1 second and about 6 seconds, no post draws, total draw of 1:1 and 1.5:1, jet draw ratios of 1:1 and 1.5:1 and bath temperature of 10° C. 70/30 BCA fibers produced under these conditions yielded an average silk factor of 8.16. The moisture pickup for the 70/30 BCA fiber averaged 3.47%. Data are shown in Table 5.

TABLE 5
Example 4 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 8.26 | 78.7 | 1.50 | 1.00 | 1.5 | 10 | 44 | 0 | 60 | 1.02 | 24 | 3.6 | 21.98 | 6.35 | 1.76 |
| 8.15 | 78.7 | 1.00 | 1.00 | 1 | 10 | 44 | 0 | 60 | 1.02 | 24 | 3.76 | 23.06 | 6.38 | 1.70 |
| 8.08 | 78.7 | 1.00 | 1.00 | 1 | 10 | 6 | 0 | 60 | 1.02 | 24 | 4.35 | 20.86 | 7.69 | 1.77 |

### Example 5—(60/40)

Blended Cellulose Acetate dopes were prepared at dope solids of 26 wt % based on the total weight of the dope. 60% of the solids was CTA and 40% was CDA, or 15.6 wt % CTA and 10.4 wt % CDA based on the total weight of the dope. The 60/40 blended dope was wet-spun into fiber samples according to the multifilament wet spinning method above. The spinning conditions yielding the optimal silk factors for the 60/40 BCA fibers included 0% DMAc bath, bath residence time of about 1 second, no post draw, total draw of 1:1 and 1.5:1, jet draw ratios of 1:1 and 1.5:1 and bath temperatures of 10° C. and 25° C. 60/40 BCA fibers produced under these conditions yielded an average silk factor of 7.99. The moisture pickup for the 60/40 BCA fiber averaged 3.73%. Data are shown in Table 6.

TABLE 6
Example 5 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 8.41 | 85.8 | 1.00 | 1.00 | 1 | 10 | 6 | 0 | 90 | 1.03 | 26 | 3.68 | 18.39 | 7.22 | 1.96 |
| 7.85 | 85.8 | 1.50 | 1.00 | 1.5 | 10 | 6 | 0 | 90 | 1.03 | 26 | 2.42 | 15.26 | 4.87 | 2.01 |
| 7.72 | 85.8 | 1.00 | 1.00 | 1 | 25 | 6 | 0 | 100 | 1.03 | 26 | 3.21 | 22.76 | 5.19 | 1.62 |

### Example 6—(40/60)

Blended Cellulose Acetate dopes were prepared at dope solids of 25 wt % based on the total weight of the dope. 40% of the solids was CTA and 60% was CDA, or 10.0 wt % CTA and 15.0 wt % CDA based on the total weight of the dope. The 40/60 blended dope was wet-spun into fiber samples according to the multifilament wet spinning method above. The spinning conditions yielding the optimal silk factors for the 40/60 BCA fibers included 0% and 45% DMAc bath concentrations, bath residence times of about 1 second and about 6 seconds, no post draw, total draw of 0.75:1 and 1:1, jet draw ratios of 0.75:1 and 1:1 and bath temperatures of 25° C. 40/60 BCA Fibers produced under these conditions yielded an average silk factor of 7.29. The moisture pickup for the 40/60 BCA fiber averaged 4.28%. Data are shown in Table 7.

TABLE 7
Example 6 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 7.35 | 82.6 | 1.00 | 1.00 | 1 | 25 | 6 | 0 | 54 | 1.03 | 25 | 4.06 | 32.32 | 5.25 | 1.29 |
| 7.29 | 82.6 | 1.00 | 1.00 | 1 | 25 | 44 | 45 | 54 | 1.03 | 25 | 3.68 | 32.32 | 4.71 | 1.28 |
| 7.24 | 82.6 | 0.75 | 1.00 | 0.75 | 25 | 6 | 0 | 54 | 1.03 | 25 | 5.15 | 36.33 | 6.18 | 1.20 |

### Example 7—(20/80)

Blended Cellulose Acetate dopes were prepared at dope solids of 27 wt % based on the total weight of the dope. 20% of the solids was CTA and 80% was CDA, or 5.4 wt % CTA and 21.6 wt % CDA based on the total weight of the dope. The 20/80 blended dope was wet-spun into fiber samples according to the multifilament wet spinning method above. The spinning conditions yielding the optimal silk factors for the 20/80 BCA fibers included 0% and 45% DMAc bath concentrations, bath residence time of about 1 second, post draw ratios of 1:1 and 1.05:1, total draw of 0.75:1 and 1.05:1, jet draw ratios of 0.75:1 and 1:1 and bath temperatures of 10° C. and 25° C. 20/80 BCA fibers produced under these conditions yielded an average silk factor of 6.94. The moisture pickup for the 20/80 BCA fiber averaged 4.46%. Data are shown in Table 8.

TABLE 8
Example 7 Data

| | | | | | | | | | | | | Break | | |
|---|---|---|---|---|---|---|---|---|---|---|---|---|---|---|
| | Through- | Draw Ratios | | | Coagulation Bath | | | Dope | | | Denier | Elon- | Break | |
| Silk | put | Jet | Post | Total | Temp | Length | DMAc | Temp | Density | Solids | (g/ | gation | Force | Tenacity |
| Factor | (mg/min) | Draw | Draw | Draw | (deg C.) | (inches) | Conc. (%) | (deg C.) | (g/cc) | (%) | 9000 m) | (%) | (gF) | (gF/den) |
| 7.19 | 89.8 | 0.75 | 1.00 | 0.75 | 25 | 6 | 45 | 54 | 1.04 | 27 | 5.67 | 34.46 | 6.91 | 1.23 |
| 7.10 | 89.8 | 0.75 | 1.00 | 0.75 | 10 | 6 | 0 | 54 | 1.04 | 27 | 5.18 | 23.96 | 7.50 | 1.45 |
| 6.53 | 89.8 | 1.00 | 1.05 | 1.05 | 25 | 6 | 45 | 54 | 1.04 | 27 | 4.14 | 19.56 | 6.11 | 1.48 |

### Example 1-7 Analysis

Cellulose triacetate fiber wet spun from 100% CTA dope has higher silk factor and lower moisture pickup than cellulose diacetate fiber wet spun from 100% CDA dope as evidenced by comparison of Examples 1 (SF=8.10) and 2 (SF=6.97). The viscosity of dope formed from CTA and DMAc solvent requires that the CTA dope must be prepared at lower solids (20-22%) than dope formed from CDA and DMAc (29%). Wet spinning processes are typically operated continuously and a higher solids concentration dope enables a higher process throughput (mass produced per unit time).

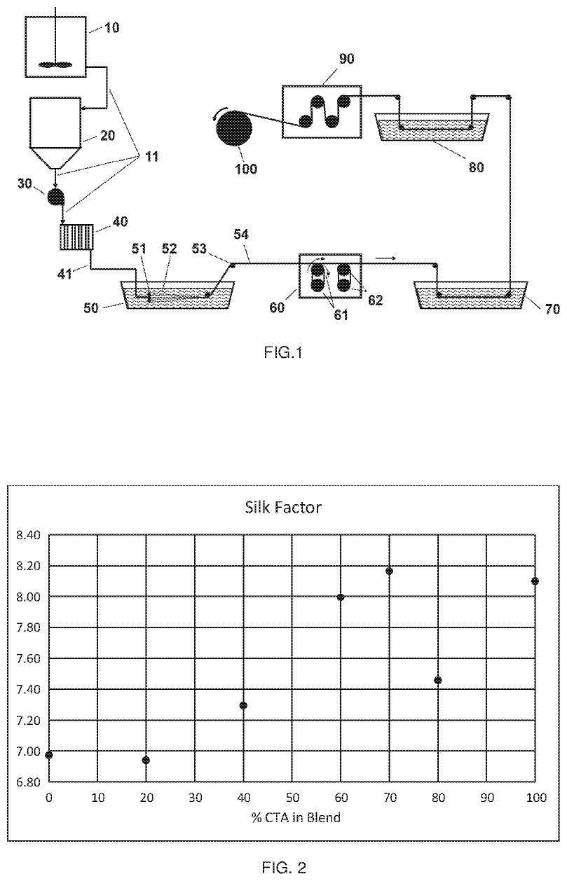

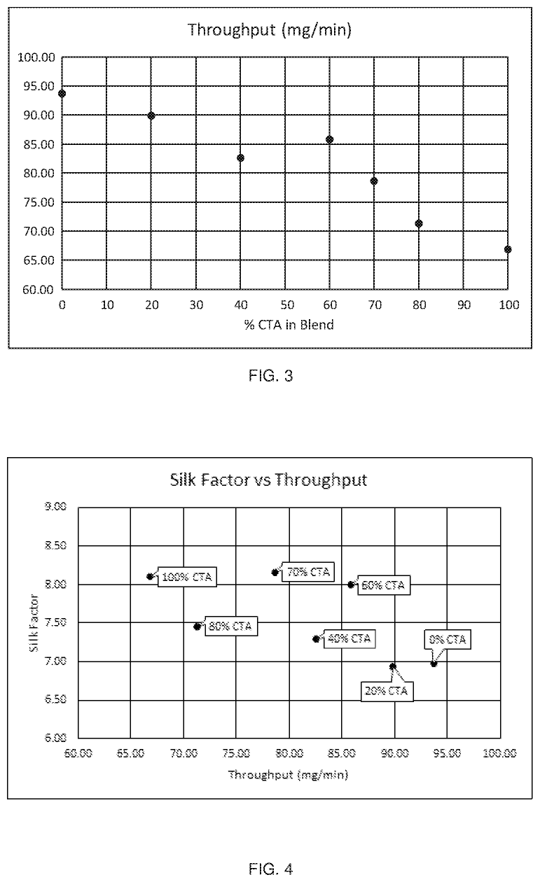

Unexpectedly, it has been found that blended dopes comprising CTA and CDA in DMAc solvent can be wet spun into fiber having equivalent or better silk factor than fiber produced from 100% CTA, as evidenced by the silk factors of Examples 4 and 5 and as shown in FIG. 2. Surprisingly, the effect is not predicted by a linear relationship from CTA to CDA as small amounts of CDA, up to 20%, negatively affect silk factor and provide no increase in moisture pickup whereas blends in the range from 25 to 50% CDA improve or maintain silk factor and improve moisture pickup at increased dope solids. Fibers produced within the blend ratios of the present invention can be produced at higher rates than 100% CTA fiber without diminishing the physical properties of the fiber in terms of silk factor. FIG. 3 is plot of the throughput for each example and the rates are directly related to the weight % solids of the CA dope being pumped to the spinneret. FIG. 4 plots the Silk Factor of each example versus the calculated throughput of each example and thus illustrates that Examples 4 and 5 (labeled “70% CTA” and 60% CTA″ respectively) have the silk factor performance of 100% CTA and can be produced at higher production rates due to their higher dope solids contents. In addition to the increased throughput enabled by increased dope solids of the present invention, the overall raw material cost to produce the blended fiber is also advantaged when compared to the cost of a pure CTA dope.

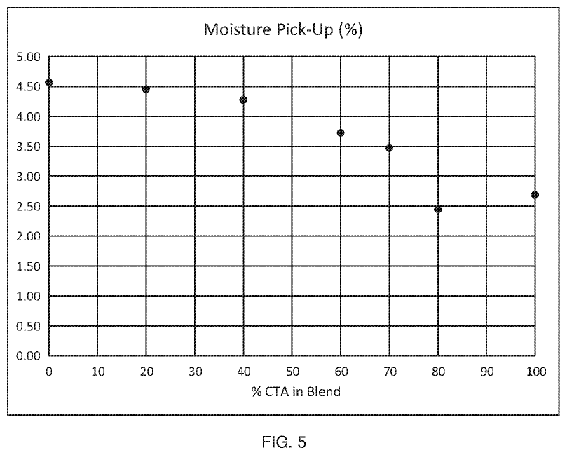

With respect to moisture pick-up which is correlated with moisture regain, FIG. 5 demonstrates that the fibers of the present invention (Examples 4 and 5) have moisture pick-up percentages greater than those of 100% CTA and 80% CTA.

### Example 8—Constituent Analysis of BCA Fiber Via Acetone Extraction

A sample of BCA fiber was prepared from a BCA dope having 60 weight % CTA and 40 weight % CDA based on the weight of the solids in the dope. The sample was analyzed via NMR and determined to have an average DS_{acetyl} of 2.75 (42.62% acetyl). In order to determine the presence of at least two cellulose acetate constituents, at least 0.4 gram of the fiber sample was submerged in at least 10 ml of acetone and held at 25° C. (±5° C.) over a period of 48 hours without stirring. The resulting solution was filtered via glass fritted funnel to separate the acetone soluble constituent material (filtrate) from the acetone insoluble constituent material (residue). The acetone insoluble constituent (extraction residue) was analyzed via NMR and determined to have an average DS_{acetyl} of 2.85 (43.51% acetyl). The acetone soluble constituent (extraction filtrate) was analyzed via NMR and determined to have an average DS_{acetyl} of 2.71 (42.29% acetyl). Likewise, a sample of 100% CTA fiber based on the weight of the solids in the dope, was analyzed via NMR and determined to have an average DS_{acetyl} of 2.90 (43.97% acetyl). The 100% CTA fiber sample underwent the same acetone extraction described above and the soluble constituent (filtrate) and insoluble constitutent (residue) were analyzed via NMR and determined to have average DS_{acetyl} values of 3.00 and 2.92 respectively, and the data are shown in Table 9.

TABLE 9

| | | DS_{Acetyl} | DS_{Acetyl} |
|---|---|---|---|
| | DS_{Acetyl} | Soluble | Insoluble |
| Sample | Fiber | Constituent | Constituent |
| BCA (60/40) | 2.75 | 2.71 | 2.85 |
| CTA (100/0) | 2.90 | 3.00 | 2.92 |

The above NMR analyses were conducted by dissolving 20-30 mg samples in 1 mL of DMSO-d6 at 80° C. TMS (tetramethylsilane) and TFA (trifluoroacetic acid) were added as a reference and a water shift reagent, respectively. All spectra were acquired on a Bruker Avance III 600 MHz system.

This acetone extraction method and NMR analysis demonstrates that the BCA fiber of the present invention is measurably distinct in its chemical structure from a cellulose acetate fiber formed from a single cellulose acetate resin having an average DS_{acetyl} of 2.75 which would yield acetone extraction constituents also having average DS_{acetyl} values of 2.75 or higher.

### Claims not Limited to Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A blended cellulose acetate fiber having an average DS_{acetyl} of at least 2.6 and comprising at least two cellulose acetate constituents.

2. The fiber according to claim 1, wherein at least one cellulose acetate constituent has an average DS_{acetyl} which is greater than the average DS_{acetyl} of said fiber.

3. The fiber according to claim 1, wherein at least one cellulose acetate constituent has an average DS_{acetyl} which is less than the average DS_{acetyl} of said fiber.

4. The fiber according to claim 2, wherein the at least one cellulose acetate constituent is cellulose triacetate.

5. The fiber according to claim 3, wherein the at least one cellulose acetate constituent is cellulose diacetate.

6. The fiber according to claim 4, wherein said cellulose triacetate constituent has an average DS_{acetyl} of at least 2.76.

7. The fiber according claim 5, wherein said cellulose diacetate constituent has an average DS_{acetyl} of not more than 2.75.

8. The fiber according to claim 1, wherein said fiber has a crystallinity in the range of 25 to 40.

9. The fiber according to claim 1, wherein said fiber exhibits a silk factor of at least 7.6.

10. The fiber according to claim 1, wherein said fiber exhibits a tenacity of at least 1.6 g/denier as measured according to ASTM D22556 and an elongation at break of at least 15 percent as measured according to ASTM D22556.

11. The fiber according to claim 1, wherein said fiber exhibits a moisture pickup of at least 3.0%.

12. The fiber according to claim 1, wherein said fiber is a wet spun fiber.

13. The fiber according to claim 1, wherein said fiber is produced without methylene chloride.

14. The fiber according to claim 1, wherein said fiber comprises cellulose acetate having at least one substituent on an anhydroglucose unit (AGU) derived from recycled plastic content syngas.

15. The fiber according to claim 1, wherein said fiber is a continuous filament product.

16. The fiber according to claim 1, wherein said fiber is cut into a staple fiber product.

17. A filament yarn comprising the fiber of claim 15.

18. A spun yarn comprising the staple fiber of claim 16.

19. An article comprising the yarns of claim 17, wherein said article is a woven textile or nonwoven substrate.

20. An article comprising the yarns of claim 17, wherein said article is a knitted textile.
